(19) United States
(12) Patent Application Publication
(10) Pub. No.: US 2017/0314313 A1
(43) Pub. Date: Nov. 2, 2017

(54) INTELLIGENT SENSING EDGE AND CONTROL SYSTEM

(71) Applicant: Rob J. Evans, Glendale, AZ (US)

(72) Inventor: Rob J. Evans, Glendale, AZ (US)

(21) Appl. No.: 15/188,935

(22) Filed: Jun. 21, 2016

Related U.S. Application Data
(60) Provisional application No. 62/330,791, filed on May 2, 2016.

(51) Int. Cl. E05F 15/42; E06B 9/68; E05F 15/72; E05F 15/60

(52) U.S. Cl. CPC E05F 15/42; E05F 15/72; E05F 15/60; E06B 9/68; E05Y 2400/32; E05Y 2400/44; E05Y 2900/134; E06B 2009/6818; E05Y 2400/52

(57) ABSTRACT

A sensing edge is made in segments that can be used to determine at which point along the edge an obstruction occurred. Data collected can be used to determine a point in a process that the fault occurred by addressing each segment individually or as a whole. A programmable controller can be operatively coupled to the sensing edge, and can include logic to control the door and/or other equipment using data collected from the sensing edge.

### CROSS-REFERENCE TO RELATED APPLICATIONS

This application claims the benefit of provisional Ser. No. 62/330,791, filed May 2, 2016, entitled “INTELLIGENT SENSING EDGE FOR MOTORIZED DOOR” to Rob J. Evans, the subject matter of which is incorporated herein by reference.

### BACKGROUND OF THE INVENTION

### 1. Field of the Invention

The present invention relates to motorized doors, and, more particularly to an intelligent sensing edge and control system for a motorized door.

### 2. Description of the Related Art

Motorized doors have many industrial and commercial uses. However, care must be taken when operating a motorized door. When a motorized door encounters a significant obstruction during closing, for instance, it may be necessary to immediately reverse the motor direction or halt the operation of the door.

The prior art is replete with safety devices for motorized door systems, such as various types of safety edges. When a door is equipped with a safety edge, a signal is typically sent to halt or reverse the motor when the edge encounters an obstruction. In other cases, a signal is interrupted, and the absence of the signal then triggers the control system to take appropriate action.

In the prior art, pneumatic air activated systems include an edge having a flexible hose that is sealed. When encountering an obstruction, the hose is compressed causing the air in the hose to push against a switch, sending a signal to a control system. While such systems are useful, they often suffer from reliability and maintenance problems.

In the prior art, electric-activated edges are more widely employed. Typically, these devices include dual conductive strips that are separated by an air gap. When encountering an obstruction, the conductive strips are pushed together completing a circuit, thereby causing a signal to be sent to the control system.

Although such prior art safety edges are very useful, they suffer from the fact that they cannot provide any information other than the fact that the door has encountered an obstruction.

### SUMMARY OF THE INVENTION

A sensing edge is made in segments that can be used to determine at which point along the edge an obstruction occurred. Data collected can be used to determine a point in a process that the fault occurred by addressing each segment individually or as a whole. A programmable controller can be operatively coupled to the sensing edge, and can include logic to control the door and/or other equipment using data collected from the sensing edge.

### BRIEF DESCRIPTION OF THE DRAWINGS

FIG. 1 illustrates an example overhead door having a sensing edge according to an embodiment of the present invention;

FIG. 2 illustrates a diagram showing the operational linkage between the sensing edge and a control system;

FIG. 3 illustrates a cutaway perspective view of an example sensing edge according to an embodiment of the present invention;

FIG. 4 illustrates a close-up view of the example sensing edge of FIG. 3; and

FIG. 5 illustrates a diagram showing that sensing edge divided into a plurality of segments.

### DETAILED DESCRIPTION OF THE INVENTION

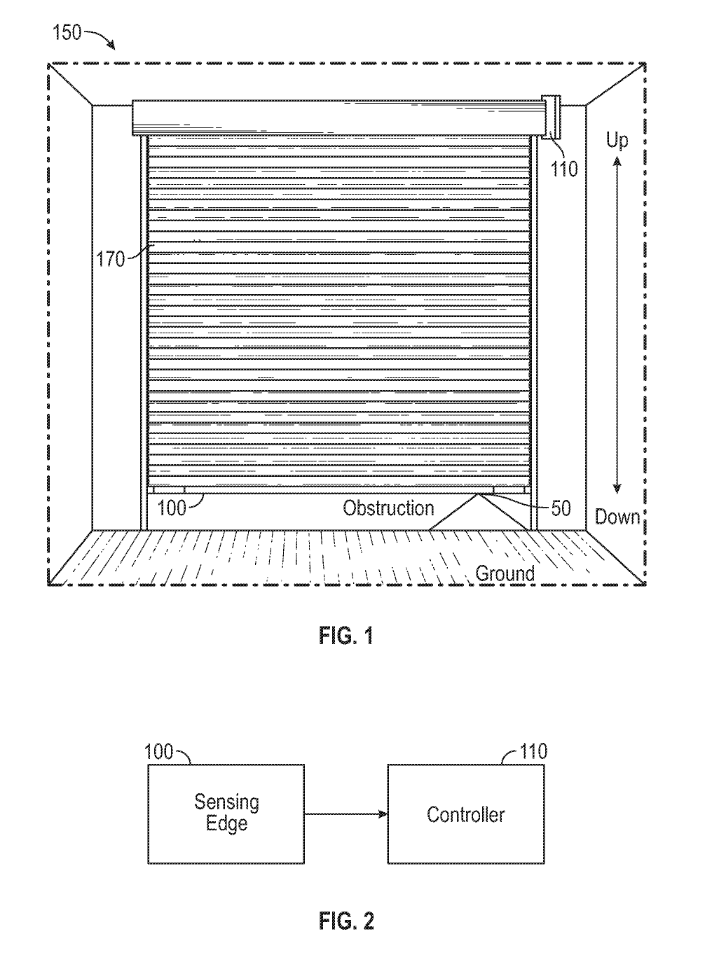

Referring to FIG. 1, an example overhead door system 150 having a sensing edge 100, according to an embodiment of the present invention, is illustrated. As shown, the overhead door system 150 includes a motorized gate 170 capable of upward and downward movement. It is to be understood that the gate 170 will move in an upward direction when opening, and in a downward direction upon closing. It is further to be understood that various different types of motorized overhead doors exist, and the illustrated gate 170 is not meant to be limiting.

In various embodiments, the gate 170 is controlled by a controller 110 operatively coupled to an electric motor operating under the direction of the controller 110. In the illustrated embodiment, the controller 110 and the electric motor are housed together. However, in other embodiments, the controller is situated elsewhere. In some embodiments, the controller 110 is situated near or along the edge 100. The controller can include a “solid state” design or be a programmed PLC, for example.

In operation, when the gate 170 starts to close it may encounter an obstruction, such as the illustrated obstruction. The obstruction could be any object, including a person, situated between the edge 100 and the ground that would interfere with operation of the door system 150. As will be described in greater detail, upon encountering the obstruction, the sensing edge 100 senses the obstruction at an impact point 50 and sends a signal to the controller 110 including data interpretable by the controller 110 as to both the existence of an obstruction and a location along the edge 100 of the impact point 50. Although one impact point 50 is shown, it is to be understood that more than one impact point could exist, and the data transmitted to the controller 110 could include data as to the existence and location of additional impact points. Furthermore, it some embodiments, additional sensors, such as optical or thermal sensors can be included near or along the edge 100 (or elsewhere), and such additional sensor information could be provided to the controller 110, either along with or separately from the tactile sensor data. In the case of a thermal sensor, such information could be useful in determining whether a fire exists. A fire door can then be closed, for example. However, if the controller 110 also determines using the tactile sensors that the fire door is obstructed or compromised, the controller 110 can cause the fire door to close incrementally. That is, the door may close a few inches at time and then stop, and repeat until it is fully closed. Alternative circuitry to accomplish this task may be provided. In this manner, a balance is maintained between keeping the fire door closed to limit the spread of the fire and not causing damage or injury, so as to allow a person in the path of or near the door to know that the door is in the process of closing.

Referring to FIG. 2, a diagram showing the operational linkage between the sensing edge 100 and the controller 110 is provided. It is to be understood that instead of a wired connection between the sensing edge 100 and the controller 110, information can alternatively or additionally be transmitted via a wireless link. For example, in an embodiment, the sensing edge 100 includes a radio transmitter capable of transmitting data to a receiver operatively connected to the controller 110. In other embodiments, the sensing edge 100 includes a transceiver capable of receiving data from the controller 110 as well as transmitting data to the controller 110.

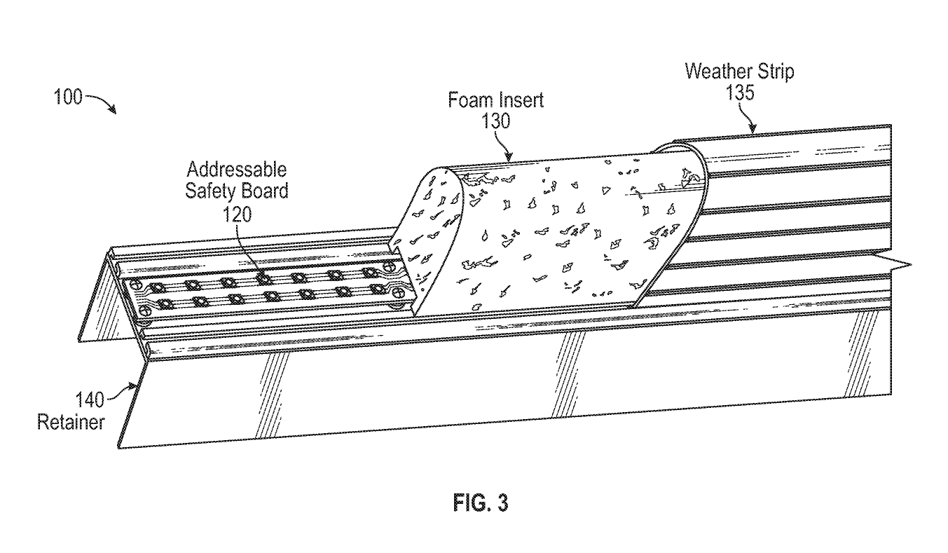

Referring to FIG. 3, a cutaway perspective view of an example sensing edge 100, according to an embodiment of the present invention, is illustrated. As illustrated, the sensing edge 100 includes a retainer 140, a safety board 120, a foam insert 130 and a weather strip 145. The retainer can be made of aluminum or a hard plastic, for example. As shown, the retainer 140 includes a top surface and opposing lateral sides disposed perpendicularly to the top surface forming a C-shaped strip. In an embodiment, the retainer 140 is about ⅛^{th} inch in thickness. The length of the retainer 140 can be any suitable size for the door.

It is to be understood that the bottom edge of the gate 170 fits between the pair of lateral sides, and the retainer 140 will be appropriately fastened to the edge of the gate using any suitable means, such as an adhesive, rivets, screws, etc. It is also to be understood that the retainer 140 can run the entire length of the edge. As shown, the safety board 120 is disposed on the top surface of the retainer 140. The safety edge 120 is encapsulated by the weather strip 135, which can be made of vinyl or another durable, flexible and weather-resistant material. The interior is filled with the foam insert 130 which can be a relatively hard foam or another suitable compressible material.

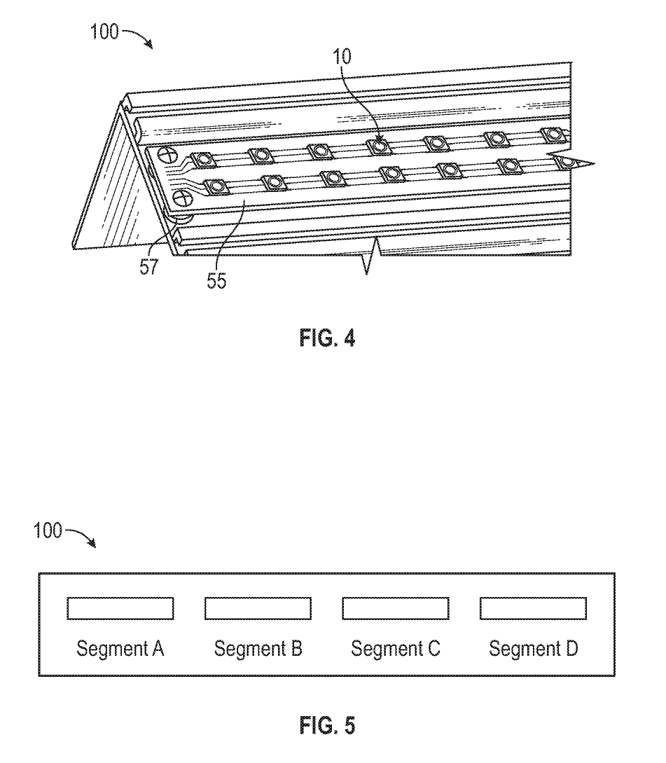

Referring to FIG. 4, a close-up view of the exemplary sensing edge 100 is illustrated. As shown, the safety board 120 includes a substrate 55 that can be a printed circuit board (PCB) or the like running substantially entirely across the length of the edge. Disposed on the substrate 55 is a plurality of tactile sensors 10. Such tactile sensors are activated upon a sufficient force being applied thereto. In operation, when the edge 100 encounters an obstruction, the force from the impact will be transferred through the weather strip 135 and the foam insert 130 to one or more tactile sensor 10. In an embodiment, upon sufficient force, the affected sensors 10 will open a circuit (using “normally closed” sensors). In other embodiments, the force will close a circuit (using “normally open” sensors). In either case, the electrical wiring of the PCB board will be such that the location of the particular sensor 10 or group of sensors 10 can be determined. In the spirit of the invention, the substrate 55 can be achieved alternatively using a flexible circuit board, individual resistive elements, an arrangement of mechanical switches, photo sensors, or any segmental conductive element such as copper or aluminum or breadboard design, etc. Additionally, a trace circuit will preferably be included along the edge and connected to the controller 110. The trace circuit can be a normally closed circuit, and if the door is severely impacted (by an automobile, for example), the trace circuit would be open due to the damage. In this event, a door fault is detected by the controller 110, and the controller 110 would take appropriate action such as instruct the door motor to be shut off. The trace additionally can have an alarm so that if an intruder pries the door open (or attempts to do so) using a crow bar or the like, it would compromise the trace and thus initiate a burglar alarm.

Referring to FIG. 5, the sensing edge 100 is shown divided into addressable segments A-D. It is to be understood that while four segments (A-D) are shown, either a greater or lesser number of segments could be provided. Furthermore, in the illustrated embodiment, each segment is addressable. However, in other embodiments, individual tactile sensors 10 could be addressable.

It is to be understood that each of the segments A-D shown includes a group of contiguous tactile sensors 10 such that when any sensor in the segment is activated, the affected segment can be determined by information sent to the controller 110. In an embodiment, each segment A-D includes fourteen tactile sensors 10 arranged as seven pairs of sensors.

In an embodiment, the segments A-D are electrically isolated. In an embodiment, each Segment A-D can include its own segment transmitter, and each segment transmitter can be operatively coupled to the controller 110. The same effect can be achieved by hard wiring each segment to a single transmitter operatively coupled to the controller 110 or hard wiring each segment to the controller 110. In other embodiments, the segments A-D are connected electrically, but each of the affected segments is individually addressable. In still other embodiments, multiple sensing edges 100 affixed to a plurality of doors are operatively coupled to a single controller 110 that is configured to control each of the doors in case of issues with the doors. In such case, each door would be assigned an identifier and each segment assigned another identifier, according to an agreed upon addressing scheme. In various embodiments, the controller 110 is disposed on the sensing edge 100 (e.g., on the PCB). In other embodiments, the controller 110 is located remotely but operatively coupled to the sensing edge 100.

In various embodiments, the controller 110 includes a CPU that can be configured (e.g., programmed) to take action based on inputs received from the sensing edge 100. The controller 110 could be a programmable logic controller (PLC) or the like, and the inputs could be a sequence of data from the sensing edge 100, for example. Additionally, the controller 110 can include a time/date module to time/date stamp received inputs and record associated actions taken. The controller 110 can further include storage to store this information.

These and other novel elements of the invention will become more apparent from the following examples. However, it is to be understood that the following examples are not meant to be limiting.

### EXAMPLE 1

In normal operation, a motorized door opens and closes in a bottling facility casing room. In a particular instance, the door closes and the sensor edge 100 is activated at Segment D because a bottle crate hits the edge there. In response to Segment D being hit, the controller 110 is configured (e.g., programmed) to halt the operation of a conveyer belt and reverse operation of the door so that the door opens slightly more, and then turn the conveyer back on, allowing the carton to clear the door. Afterwards, the door is closed. Advantageously, the controller can be configured (e.g., programmed) to control a door and other machinery such as the conveyer belt.

### EXAMPLE 2

In normal operation a door opens and closes in an automated assembly line. During operation, it is not unusual for there to be an obstruction along the middle edge segments B-C but obstructions along outer edge segments A and D indicates a serious problem. The controller 110 can be configured to open the door slightly more when the inner segments are activated but entirely shut the system down if any outer segment is activated.

### EXAMPLE 3

During litigation over an injury allegedly caused by a faulty motorized door, the plaintiff or a witness may claim certain facts that are verifiable through analysis of collected data from the edge 100. In this case, the data can be time stamped and recorded for later use. The sequence of door operations, including the location of any impacts along the door, can be determined. The height of the door can be determined given the known rate of closure speed, the time between start of closing and the time of the obstruction event, etc.

### EXAMPLE 4

During litigation over property damage allegedly caused by a barrier arm hitting a car in a parking facility, it is determined that the damage to the car is consistent only with the middle portion of the barrier striking the windshield. Using collected and time-stamped data from an edge attached to the barrier arm, the accident can be reconstructed and the claim verified.

### EXAMPLE 5

Upon a proper initial installation of a door, it is determined that 10% of the tactile sensors are activated when the door is closed. However, over time it is noted that when the door is closed, 30% of the sensors are activated indicating that the door is hitting the ground harder than necessary. In this case, a mechanic can be sent to inspect the door, or the door can be rendered to a stop state and/or operation which requires an end user to be in full site of operation until door problem is remedied.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. An intelligent sensing edge system, comprising
a plurality of addressable tactile sensors arranged along a safety edge; and
a controller operatively connected to the tactile sensors;
wherein, responsive to application of a force against the safety edge, the controller is able to determine a location along the length of the safety edge where the force was applied using data provided from the tactile sensors.

2. The intelligent sensing edge system of claim 1, wherein the safety edge is capable of attachment to an edge of a motorized door.

3. The intelligent sensing edge system of claim 1, wherein the safety edge further comprises a substrate, a weather strip and an insert;
wherein the sensors are arranged longitudinally across the substrate, the weather strip encapsulates the tactile sensors and the substrate, and the insert fills an interior space between the sensors and the weather strip.

4. The intelligent sensing edge system of claim 1, wherein the sensors are grouped into sectors, each sector separately addressable.

5. The intelligent sensing edge system of claim 1, wherein the substrate is a printed circuit board and the sensors are embedded thereon.

6. The intelligent sensing edge system of claim 1, wherein the substrate includes a flexible circuit board or a breadboard.

7. The intelligent sensing edge of claim 1, wherein the safety edge comprises a trace circuit connected to the controller permitting the controller to determine whether the safety edge is compromised.

8. The intelligent sensing edge system of claim 1, wherein the sensors include one or more of individual resistive elements, an arrangement of mechanical switches, photo sensors, and a segmental conductive element.

9. The intelligent sensing edge system of claim 1, wherein the controller is capable of recording historical data regarding the state of the edge during operation upon a storage medium.

10. The intelligent sensing edge system of claim 1, wherein the controller is configured to control multiple pieces of automated equipment.

11. The intelligent sensing edge of claim 1, further comprising at least one thermal sensor arranged on or near the edge, wherein responsive to the at least one thermal sensor being activated, the controller causes at least one fire door to close.

12. The intelligent sensing edge of claim 11, wherein the controller causes the at least one fire door to incrementally close when the at least one thermal sensor is activated and an obstruction is detected based upon data received from one or more of the tactile sensors.

13. The intelligent sensing edge of claim 11, wherein the controller causes the at least one fire door to close using alternative circuity.

14. An intelligent sensing edge, comprising:
a plurality of sensors arranged along an edge of a motorized door;
wherein, responsive to application of a force against the edge, a controller operatively coupled to the sensors is able to determine a location along the edge where the force was applied using data provided from the sensors.

15. The intelligent sensing edge of claim 14, wherein the sensors are tactile sensors.

16. The intelligent sensing edge of claim 14, wherein the sensors are grouped into sectors, each sector separately addressable, where the sensors of each group are contiguous.

17. The intelligent sensing edge of claim 14, further comprising a substrate, a weather strip and an insert; wherein the sensors are arranged longitudinally across the substrate, the weather strip encapsulates the sensors and the substrate, and the insert fills an interior space between the sensors and the weather strip.

18. The intelligent sensing edge of claim 17, wherein the substrate is a printed circuit board and the sensors are embedded thereon.

19. The intelligent sensing edge of claim 17, wherein the sensors are hardwired to the controller.

20. The intelligent sensing edge of claim 14, wherein the sensors are wirelessly connected to the controller.

21. The intelligent sensing edge of claim 14, wherein the controller is connected to and controls a motorized door system.

22. The intelligent sensing edge of claim 14, wherein the controller is programmable.

23. The intelligent sensing edge of claim 14, wherein the controller is capable of recording historical data regarding the state of the edge during operation upon a storage medium.

24. The intelligent sensing edge of claim 14, wherein the edge is an edge of a barrier arm.
